(19) United States
(12) Patent Application Publication
(10) Pub. No.: US 2015/0365484 A1
(43) Pub. Date: Dec. 17, 2015

(54) METHOD AND SYSTEM FOR MAINTAINING SESSION, NETWORK SIDE, TERMINAL AND COMPUTER STORAGE MEDIUM

(71) Applicant: ZTE CORPORATION, Shenzhen, Guangdong (CN)

(72) Inventors: Yuanfang YU, Shenzhen (CN); Xiaowu ZHAO, Shenzhen (CN); Ting LU, Shenzhen (CN)

(21) Appl. No.: 14/764,200

(22) PCT Filed: Jan. 15, 2014
(86) PCT No.: PCT/CN2014/070657

§ 371 Date: Jul. 29, 2015

(30) Foreign Application Priority Data
Mar. 4, 2013 (CN) 201310068241.5

(51) Int. Cl. H04L 29/08; H04W 76/04; H04L 29/06

(52) U.S. Cl. CPC H04L 67/145; H04L 69/168; H04W 76/045; H04W 80/06

(57) ABSTRACT

A a method for maintaining a Point-to-Point Protocol (PPP) session when a terminal is powered off is provided. The method includes that a network side receives terminal power-off indication information sent by a terminal when the terminal is powered off (101); and when determining according to the terminal power-off indication information that the terminal needs to maintain a PPP session in a power-off state, a PPP session release operation is not triggered (102). A system, a network side, a terminal and a computer storage medium for maintaining a PPP session when the terminal is powered off are also provided.

### TECHNICAL FIELD

The present disclosure relates to a terminal power-off technology in a wireless communication system, and in particular to a method, system, a network side, a terminal and a computer storage medium for maintaining a Point-to-Point Protocol (PPP) session when a terminal is powered off.

### BACKGROUND

In the existing wireless communication system, such as a Code Division Multiple Access (CDMA) 1x network, when a terminal is powered off and the wireless communication network is informed of such power-off, the wireless communication network will be triggered to release a stored packet data session in a dormant state or an active state between the wireless communication system and the terminal; but the release of the packet data session will cause a PPP session to be released. For example, for power-off of a dormant-state terminal like a Mobile Station (MS), a Base Station (BS) triggers release of the packet data session in a dormant state according to an indication of a Mobility Switch Centre (MSC); for the power-off process of the MS in the activated packet data session, the BS informs the MSC and a Packet Control Function (PCF) to release corresponding connection, the PCF informs a Packet Data Serving Node (PDSN) to release the packet data session corresponding to the MS. Thus, when the MS is powered on again, reestablishment of the packet data session and the PPP session will be triggered; the establishment process takes about 2 seconds, and the time delay will increase the battery consumption of the MS to some extent.

For a traditional terminal, it will not be powered on or off frequently, so the battery consumption caused by an operation of powering on or off is not obvious; however, with the rise of Machine to Machine (M2M) and other applications, the traditional mode is challenged; according to the application type of M2M, for example, small data in a certain period, an M2M terminal may be powered on or off frequently and has a relatively strong demand for saving power; if the power-off of each time comes with clearance of all the packet session information, and it is needed to re-establish all the packet session information when the terminal is powered on each time, then the battery consumption will increase significantly, thus adversely affecting the deployment of M2M terminal and M2M application.

### SUMMARY

For solving the technical problem, the present disclosure provides a method, a system, a network side, a terminal and a computer storage medium for maintaining a PPP session when a terminal is powered off.

The method for maintaining a PPP session when a terminal is powered off in the present disclosure may include:

receiving terminal power-off indication information sent by a terminal when the terminal is powered off; and when it is determined according to the terminal power-off indication information that the terminal needs to maintain a PPP session in a power-off state, not triggering a PPP session release operation.

In the above solution, the step of receiving terminal power-off indication information sent by a terminal when the terminal is powered off may include that an access network of a network side receives a registration message including the terminal power-off indication information, wherein the registration message is sent by the terminal when the terminal which is an idle terminal in a packet data session dormant state is powered off;

the terminal power-off indication information at least may include one of the followings: a terminal power-off indication, a terminal type, an indication of a terminal maintaining a PPP session and a M2M terminal power-off indication.

In the above solution, the step of when it is determined according to the terminal power-off indication information that the terminal needs to maintain a PPP session in a power-off state, not triggering a PPP session release operation may include that:

after the access network of the network side receives a registration request message from the idle terminal in the packet data session dormant state, the access network transmits, through a location update request message, the terminal power-off indication information in the registration request message to a circuit domain core network of the network side;

when the circuit domain core network determines according to the terminal power-off indication information that the terminal needs to maintain the PPP session in the power-off state, the circuit domain core network sends a location update acceptance message to the access network, wherein the location update acceptance message contains the indication of a terminal maintaining a PPP session; and

according to the indication of a terminal maintaining a PPP session, the access network does not trigger the PPP session release operation.

In the above solution, the step of the circuit domain core network determining according to the terminal power-off indication information that the terminal needs to maintain the PPP session in the power-off state may include that:

when the terminal power-off indication information only includes the terminal power-off indication, the circuit domain core network acquires from other network elements except itself or from storage information the terminal type and information about whether the terminal of the terminal type needs to maintain the PPP session, and when the terminal of the terminal type needs to maintain the PPP session, it is determined that the terminal needs to maintain the PPP session in the power-off state;

when the terminal power-off indication information includes the terminal power-off indication and the terminal type, the circuit domain core network acquires from other network elements except itself or storage information the information about whether the terminal of the terminal type needs to maintain the PPP session, when the terminal of the terminal type needs to maintain the PPP session, it is determined that the terminal needs to maintain the PPP session in the power-off state;

when the terminal power-off indication information includes the indication of a terminal maintaining a PPP session, it is determined that the terminal needs to maintain the PPP session in the power-off state;

when the terminal power-off indication information includes the M2M terminal power-off indication, the circuit domain core network acquires, from its own configuration information, information about whether the M2M terminal is supported to maintain the PPP session, when the M2M terminal is supported to maintain the PPP session, it is determined that the terminal needs to maintain the PPP session in the power-off state.

In the above solution, the step of when it is determined according to the terminal power-off indication information that the terminal needs to maintain the PPP session in the power-off state, not triggering the PPP session release operation may include that:

after the access network of the network side receives a registration request message from the idle terminal in the packet data session dormant state, the access network transmits through the location update request message the terminal power-off indication information in the registration request message to the circuit domain core network of the network side;

the circuit domain core network accepts a registration request about terminal power-off, and sends a location update acceptance message to the access network; and

the access network receives the location update acceptance message, and determines according to the terminal power-off indication information that the terminal needs to maintain the PPP session in the power-off state, and the access network does not trigger the PPP session release operation.

In the above solution, the step of receiving terminal power-off indication information sent by a terminal when the terminal is powered off may include that the access network of the network side receives a release command message including the terminal power-off indication information, wherein the release command message is sent when a terminal in a packet session activated state is powered off;

the terminal power-off indication information at least may include one of the followings: a terminal power-off indication, a terminal type, an indication of a terminal maintaining a PPP session and a M2M terminal power-off indication.

In the above solution, the step of when it is determined according to the terminal power-off indication information that the terminal needs to maintain the PPP session in the power-off state, not triggering the PPP session release operation may include that:

after the access network of the network side receives the release command message from the terminal in the packet session activated state, the access network determines according to the terminal power-off indication information in the release command message that the terminal needs to maintain the PPP session in the power-off state, and informs a circuit domain core network and a packet domain core network of the network side to execute an operation of releasing the terminal to enter a dormant state.

In the above solution, the step of the access network determining according to the terminal power-off indication information that the terminal needs to maintain the PPP session in the power-off state may include that:

when the terminal power-off indication information only includes the terminal power-off indication, the access network acquires from other network elements except itself or from storage information the terminal type and information about whether the terminal of the terminal type needs to maintain the PPP session, and when the terminal of the terminal type needs to maintain the PPP session, it is determined that the terminal needs to maintain the PPP session in the power-off state;

when the terminal power-off indication information includes the terminal power-off indication and the terminal type, the access network acquires from its own configuration information the information about whether the terminal of the terminal type needs to maintain the PPP session, and when the terminal of the terminal type needs to maintain the PPP session, it is determined that the terminal needs to maintain the PPP session in the power-off state;

when the terminal power-off indication information may include the indication of a terminal maintaining a PPP session, it is determined that the terminal needs to maintain the PPP session in the power-off state; and

when the terminal power-off indication information includes the M2M terminal power-off indication, the access network acquires, from its own configuration information, information about whether the M2M terminal is supported to maintain the PPP session, when the M2M terminal is supported to maintain the PPP session, it is determined that the terminal needs to maintain the PPP session in the power-off state.

The method for maintaining a PPP session when a terminal is powered off provided by the present disclosure includes that:

when a terminal is in an idle state of a packet data session dormant state, the terminal sends a registration message including terminal power-off indication information to a network side when it is powered off;

when the terminal is in a packet session activated state, the terminal sends a release command message including terminal power-off indication information to the network side when it is powered off.

In the above solution, the terminal power-off indication information at least may include one of the followings: a terminal power-off indication, a terminal type, an indication of a terminal maintaining a PPP session and a M2M terminal power-off indication.

A method for maintaining a PPP session when a terminal is powered off provided by another embodiment of the present disclosure includes that:

when a terminal is in an idle state of a packet data session dormant state, the terminal sends a registration message including terminal power-off indication information to a network side when it is powered off; when the terminal is in a packet session activated state, the terminal sends a release command message including terminal power-off indication information to the network side when it is powered off;

the network side receives the terminal power-off indication information sent by the terminal when the terminal is powered off, and does not trigger a PPP session release operation when determining according to the terminal power-off indication information that the terminal needs to maintain the PPP session in the power-off state.

A network side provided by the present disclosure is configured to receive terminal power-off indication information sent by a terminal when the terminal is powered off, and not trigger a PPP session release operation when determining according to the terminal power-off indication information that the terminal needs to maintain a PPP session in a power-off state.

In the above solution, the network side may be further configured to receive a registration message including the terminal power-off indication information, wherein the registration message is sent by the terminal when the terminal which is an idle terminal in the packet data session dormant state is powered off;

the terminal power-off indication information at least may include one of the followings: a terminal power-off indication, a terminal type, an indication of a terminal maintaining a PPP session and a M2M terminal power-off indication.

In the above solution, the network side may include a first access network and a first circuit domain core network; wherein,

the first access network is configured to, after receiving the registration request message from the idle terminal in the packet data session dormant state, transmit through the location update request message the terminal power-off indication information in the registration request message to the first circuit domain core network, and not trigger the PPP session release operation according to the indication of a terminal maintaining a PPP session contained in the location update acceptance message which is sent by the first circuit domain core network; and

the first circuit domain core network is configured to, when determining according to the terminal power-off indication information that the terminal needs to maintain the PPP session in the power-off state, send a location update acceptance message to the first access network, wherein the location update acceptance message contains the indication of a terminal maintaining a PPP session.

In the above solution, the first circuit domain core network may be further configured to, when the terminal power-off indication information only includes the terminal power-off indication, acquire from other network elements except itself or from storage information the terminal type and information about whether the terminal of the terminal type needs to maintain the PPP session, and determine that the terminal needs to maintain the PPP session in the power-off state when the terminal of the terminal type needs to maintain the PPP session;

the first circuit domain core network is further configured to, when the terminal power-off indication information may include the terminal power-off indication and the terminal type, acquire from other network elements except itself or from storage information the information about whether the terminal of the terminal type needs to maintain the PPP session, and determine that the terminal needs to maintain the PPP session in the power-off state when the terminal of the terminal type needs to maintain the PPP session;

the first circuit domain core network is further configured to, when the terminal power-off indication information includes the indication of a terminal maintaining a PPP session, determine that the terminal needs to maintain the PPP session in the power-off state; and

the first circuit domain core network is further configured to, when the terminal power-off indication information includes the M2M terminal power-off indication, acquire, from its own configuration information, information about whether the M2M terminal is supported to maintain the PPP session, and determine that the terminal needs to maintain the PPP session in the power-off state when the M2M terminal is supported to maintain the PPP session.

In the above solution, the network side further may include a second access network and a second circuit domain core network; wherein,

the second access network is configured to, after receiving a registration request message from the idle terminal in the packet data session dormant state, transmit through a location update request message the terminal power-off indication information in the registration request message to the second circuit domain core network, and after receiving a location update acceptance message, not trigger the PPP session release operation when determining according to the terminal power-off indication information that the terminal needs to maintain the PPP session in the power-off state; and

the second circuit domain core network is specifically configured to accept the registration request about terminal power-off, and send the location update acceptance message to the second access network.

In the above solution, the network side is further configured to receive the release command message including the terminal power-off indication information, wherein the release command message is sent when the terminal in the packet session activated state is powered off;

the terminal power-off indication information at least may include one of the followings: a terminal power-off indication, a terminal type, an indication of a terminal maintaining a PPP session and a M2M terminal power-off indication.

In the above solution, the network side further may include a third access network, a third circuit domain core network and a packet domain core network; wherein,

the third access network is configured to, after receiving the release command message from the terminal in the packet session activated state, inform the third circuit domain core network and the packet domain core network to execute the operation of releasing the terminal to enter a dormant state when determining according to the terminal power-off indication information in the release command message that the terminal needs to maintain the PPP session in the power-off state;

the third circuit domain core network is configured to execute the operation of releasing the terminal to enter a dormant state; and

the packet domain core network is configured to execute the operation of releasing the terminal to enter a dormant state.

In the above solution, the second access network and the third access network are further configured to, when the terminal power-off indication information only may include the terminal power-off indication, acquire from other network elements except themselves or from storage information the terminal type and information about whether the terminal of the terminal type needs to maintain the PPP session, and determine that the terminal needs to maintain the PPP session in the power-off state when the terminal of the terminal type needs to maintain the PPP session;

the second access network and the third access network are further configured to, when the terminal power-off indication information includes the terminal power-off indication and the terminal type, acquire from their own configuration information the information about whether the terminal of the terminal type needs to maintain the PPP session, and determine that the terminal needs to maintain the PPP session in the power-off state when the terminal of the terminal type needs to maintain the PPP session;

the second access network and the third access network are further configured to, when the terminal power-off indication information includes the indication of a terminal maintaining a PPP session, determine that the terminal needs to maintain the PPP session in the power-off state;

the second access network and the third access network are further configured to, when the terminal power-off indication information includes the M2M terminal power-off indication, acquire, from their own configuration information, information about whether the M2M terminal is supported to maintain the PPP session, and determine that the terminal needs to maintain the PPP session in the power-off state when the M2M terminal is supported to maintain the PPP session.

The terminal provided by the present disclosure includes a power-off indication module, which is configured to, when the terminal is an idle terminal in a packet data session dormant state, send a registration message including terminal power-off indication information to a network side when it is powered off, and also configured to, when the terminal is a terminal in a packet session activated state, send a release command message including terminal power-off indication information to the network side when it is powered off.

In the above solution, the terminal power-off indication information at least may include one of the followings: a terminal power-off indication, a terminal type, an indication of a terminal maintaining a PPP session and a M2M terminal power-off indication.

The system for maintaining a PPP session when a terminal is powered off provided by the present disclosure includes the aforesaid terminal and the network side.

In the present disclosure, a computer storage medium stores a computer program, wherein the computer program is for executing the aforesaid method for maintaining a PPP session when a terminal is powered off.

The present disclosure provides a method, a system, a network side, a terminal and a computer storage medium for maintaining a PPP session when a terminal is powered off; the network side receives terminal power-off indication information sent by a terminal when the terminal is powered off, and does not trigger a PPP session release operation when determining according to the terminal power-off indication information that the terminal needs to maintain the PPP session in a power-off state; in this way, the terminal of M2M and other types is enabled to maintain PPP session information always online when it is powered off, which avoids battery consumption caused by re-establishing a PPP session when the terminal is powered on again, thus meeting the requirement of the terminal for saving power better.

### BRIEF DESCRIPTION OF THE DRAWINGS

FIG. 1 is a first flowchart of a method for maintaining a PPP session when a terminal is powered off provided by an embodiment of the present disclosure;

FIG. 2 is a second flowchart of a method for maintaining a PPP session when a terminal is powered off provided by an embodiment of the present disclosure;

FIG. 3 is a third flowchart of a method for maintaining a PPP session when a terminal is powered off provided by an embodiment of the present disclosure;

FIG. 4 is a schematic structural diagram of a system for maintaining a PPP session when a terminal is powered off provided by an embodiment of the present disclosure;

FIG. 5 is a schematic structural diagram of a first network side provided by an embodiment of the present disclosure;

FIG. 6 is a schematic structural diagram of a second network side provided by an embodiment of the present disclosure;

FIG. 7 is a schematic structural diagram of a third network side provided by an embodiment of the present disclosure;

FIG. 8 is a flowchart of a method for maintaining a PPP session when a terminal is powered off provided by the first embodiment of the present disclosure;

FIG. 9 is a flowchart of a method for maintaining a PPP session when a terminal is powered off provided by the second embodiment of the present disclosure; and

FIG. 10 is a flowchart of a method for maintaining a PPP session when a terminal is powered off provided by the third embodiment of the present disclosure.

### DETAILED DESCRIPTION

In the present disclosure, the network side receives terminal power-off indication information sent by a terminal when the terminal is powered off, and does not trigger a PPP session release operation when determining according to the terminal power-off indication information that the terminal needs to maintain a PPP session in a power-off state; wherein, the terminal power-off indication information at least includes one of the followings: a terminal power-off indication, a terminal type, an indication of a terminal maintaining a PPP session and a M2M terminal power-off indication.

The present disclosure is further elaborated below with reference to the accompanying drawings and embodiments.

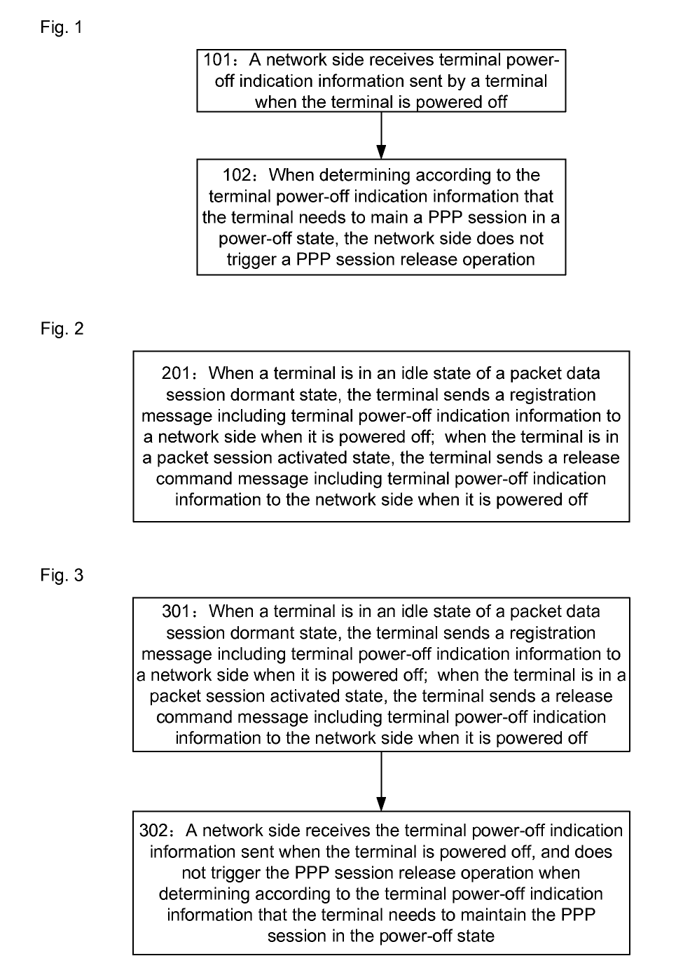

The present disclosure implements a method for maintaining a PPP session when a terminal is powered off; as shown in FIG. 1, the method includes the following steps.

Step 101 includes that a network side receives terminal power-off indication information sent by a terminal when the terminal is powered off;

specifically, an access network of the network side receives a registration message including terminal power-off indication information, wherein the registration message is sent by an idle terminal in a packet data session dormant state when the idle terminal is powered off; or,

an access network of the network side receives a release command message including terminal power-off indication information, wherein the release command message is sent by a terminal in a packet session activated state when the terminal is powered off;

the terminal power-off indication information at least includes one of the followings: a terminal power-off indication, a terminal type, an indication of a terminal maintaining a PPP session and a M2M terminal power-off indication.

Step 102 includes that when determining according to the terminal power-off indication information that the terminal needs to maintain a PPP session in a power-off state, the network side does not trigger a PPP session release operation.

The first processing way of this step is that: after the access network of the network side receives a registration request message from the idle terminal in the packet data session dormant state, the access network transmits, through a location update request message, the terminal power-off indication information in the registration request message to a circuit domain core network of the network side; when the circuit domain core network determines according to the terminal power-off indication information that the terminal needs to maintain the PPP session in the power-off state, the circuit domain core network sends a location update acceptance message to the access network, wherein the location update acceptance message contains an indication of a terminal maintaining a PPP session; according to the indication of a terminal maintaining a PPP session, the access network does not trigger the PPP session release operation;

the step of the circuit domain core network determining according to the terminal power-off indication information that the terminal needs to maintain the PPP session in the power-off state includes that:

when the terminal power-off indication information only includes the terminal power-off indication, the circuit domain core network acquires, from other network elements except itself or from storage information, the terminal type and information about whether the terminal of the terminal type needs to maintain the PPP session, and when the terminal of the terminal type needs to maintain the PPP session, it is determined that the terminal needs to maintain the PPP session in the power-off state;

when the terminal power-off indication information includes the terminal power-off indication and the terminal type, the circuit domain core network acquires, from other network elements except itself or from storage information, information about whether the terminal of the terminal type needs to maintain the PPP session, and when the terminal of the terminal type needs to maintain the PPP session, it is determined that the terminal needs to maintain the PPP session in the power-off state;

when the terminal power-off indication information includes the indication of a terminal maintaining a PPP session, it is determined that the terminal needs to maintain the PPP session in the power-off state;

when the terminal power-off indication information includes the M2M terminal power-off indication, the circuit domain core network acquires, from its own configuration information, information about whether the M2M terminal is supported to maintain the PPP session, and when the M2M terminal is supported to maintain the PPP session, it is determined that the terminal needs to maintain the PPP session in the power-off state.

The second processing way of this step is that: after the access network of the network side receives a registration request message from the idle terminal in the packet data session dormant state, the access network transmits through a location update request message the terminal power-off indication information in the registration request message to a circuit domain core network of the network side; the circuit domain core network accepts the registration request about terminal power-off, and sends a location update acceptance message to the access network; the access network receives the location update acceptance message, and determines according to the terminal power-off indication information that the terminal needs to maintain the PPP session in the power-off state, and the access network does not trigger the PPP session release operation;

the step of the access network determining according to the terminal power-off indication information that the terminal needs to maintain the PPP session in the power-off state includes that:

when the terminal power-off indication information only includes the terminal power-off indication, the access network acquires, from other network elements except itself or from storage information, the terminal type and information about whether the terminal of the terminal type needs to maintain the PPP session, and when the terminal of the terminal type needs to maintain the PPP session, it is determined that the terminal needs to maintain the PPP session in the power-off state;

when the terminal power-off indication information includes the terminal power-off indication and the terminal type, the access network acquires, from its own configuration information, information about whether the terminal of the terminal type needs to maintain the PPP session, and when the terminal of the terminal type needs to maintain the PPP session, it is determined that the terminal needs to maintain the PPP session in the power-off state;

when the terminal power-off indication information includes the indication of a terminal maintaining a PPP session, it is determined that the terminal needs to maintain the PPP session in the power-off state; and

when the terminal power-off indication information includes the M2M terminal power-off indication, the access network acquires, from its own configuration information, information about whether the M2M terminal is supported to maintain the PPP session, and when the M2M terminal is supported to maintain the PPP session, it is determined that the terminal needs to maintain the PPP session in the power-off state.

The third processing way of this step is that: after the access network of the network side receives the release command message from the terminal in the packet session activated state, the access network determines according to the terminal power-off indication information in the release command message that the terminal needs to maintain the PPP session in the power-off state, and informs a circuit domain core network and a packet domain core network of the network side to execute an operation of releasing the terminal to enter a dormant state;

the step of the access network determining according to the terminal power-off indication information that the terminal needs to maintain the PPP session in the power-off state is implemented the same as that in the second processing way.

The present disclosure implements a method for maintaining a PPP session when a terminal is powered off; the method in this example is applicable to a terminal side; as shown in FIG. 2, the method includes the following step:

step 201: when a terminal is in an idle state of a packet data session dormant state, the terminal sends a registration message including terminal power-off indication information to a network side when it is powered off; when the terminal is in a packet session activated state, the terminal sends a release command message including terminal power-off indication information to the network side when it is powered off.

In the above solution, the terminal power-off indication information at least may include one of the followings: a terminal power-off indication, a terminal type, an indication of a terminal maintaining a PPP session, and a M2M terminal power-off indication.

The present disclosure implements a method for maintaining a PPP session when a terminal is powered off; as shown in FIG. 3, the method includes the following steps:

step 301: when a terminal is in an idle state of a packet data session dormant state, the terminal sends a registration message including terminal power-off indication information to a network side when it is powered off; when the terminal is in a packet session activated state, the terminal sends a release command message including terminal power-off indication information to the network side when it is powered off; and

step 302: the network side receives the terminal power-off indication information sent by the terminal when the terminal is powered off, and does not trigger a PPP session release operation when determining according to the terminal power-off indication information that the terminal needs to maintain a PPP session in the power-off state.

Those skilled in the art should appreciate that step 301 and step 302 in the above solution can be understood with reference to related description of the method for maintaining a PPP session when a terminal is powered off shown in FIG. 1 and FIG. 2.

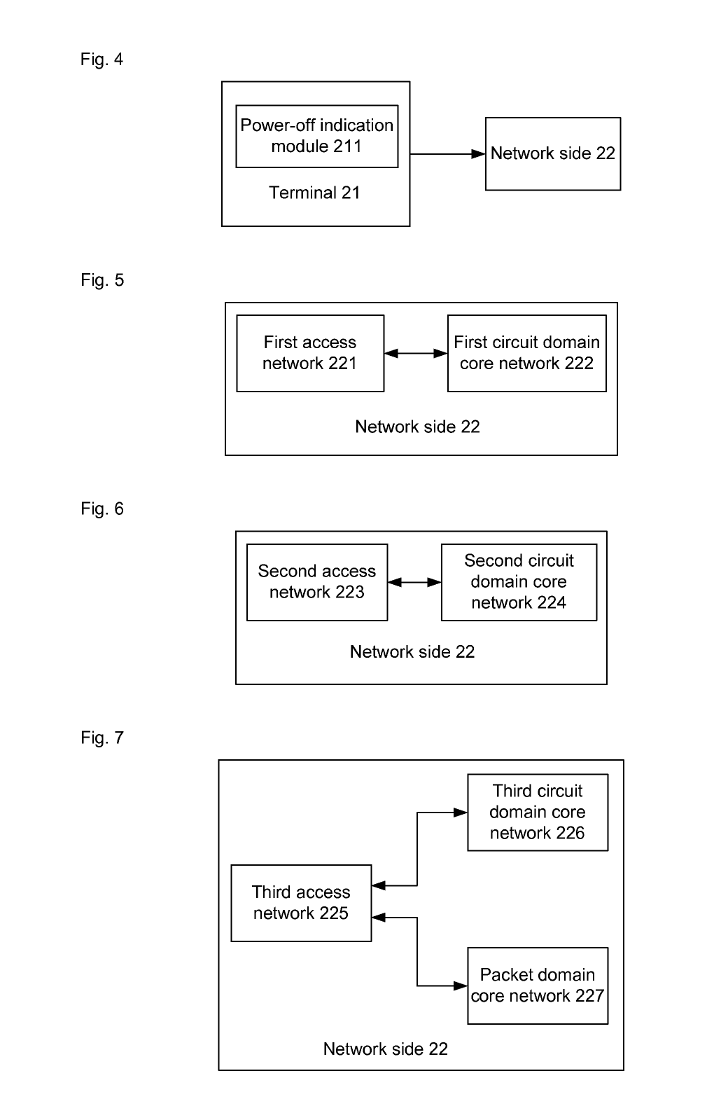

For implementing the above method, the present disclosure also provides a terminal; as shown in FIG. 4, the terminal includes a power-off indication module 211, which is configured to, when the terminal is an idle terminal in a packet data session dormant state, send a registration message including terminal power-off indication information to a network side 22 when the terminal is powered off; and also configured to, when the terminal is in a packet session activated state, send a release command message including terminal power-off indication information to the network side 22 when the terminal is powered off;

the terminal power-off indication information at least includes one of the followings: a terminal power-off indication, a terminal type, an indication of a terminal maintaining a PPP session, and a M2M terminal power-off indication.

In a practical application, the power-off indication module 211 in the terminal may be implemented by a Central Processing Unit (CPU), or a Digital Signal Processor (DSP), or a Field-Programmable Gate Array (FPGA) in the terminal.

For implementing the above method, the present disclosure also provides a network side; as shown in FIG. 5, the network side 22 is configured to receive terminal power-off indication information sent by a terminal when the terminal is powered off, and not trigger a PPP session release operation when determining according to the terminal power-off indication information that the terminal needs to maintain a PPP session in the power-off state.

Preferably, the network side is further configured to receive a registration message including the terminal power-off indication information, wherein the registration message is sent by the terminal when the terminal which is an idle terminal in the packet data session dormant state is powered off;

the terminal power-off indication information at least may include one of the followings: a terminal power-off indication, a terminal type, an indication of a terminal maintaining a PPP session, and a M2M terminal power-off indication.

Preferably, the network side 22 includes a first access network 221 and a first circuit domain core network 222; wherein,

the first access network 221 is configured to, after receiving a registration request message from the idle terminal in the packet data session dormant state, transmit through a location update request message the terminal power-off indication information in the registration request message to the first circuit domain core network 222, and not trigger a PPP session release operation according to the indication of a terminal maintaining a PPP session contained in a location update acceptance message which is sent by the first circuit domain core network 222; and

the first circuit domain core network 222 is configured to, when determining according to the terminal power-off indication information that the terminal 21 needs to maintain the PPP session in the power-off state, send the location update acceptance message to the first access network 221, wherein the location update acceptance message contains the indication of a terminal maintaining a PPP session.

The first circuit domain core network 222 is further configured to:

when the terminal power-off indication information only includes the terminal power-off indication, acquire, from other network elements except itself or from storage information, the terminal type and information about whether the terminal of the terminal type needs to maintain the PPP session, and determine that the terminal 21 needs to maintain the PPP session in the power-off state when the terminal of the terminal type needs to maintain the PPP session;

when the terminal power-off indication information includes the terminal power-off indication and the terminal type, acquire, from other network elements except itself or from storage information, information about whether the terminal of the terminal type needs to maintain the PPP session, and determine that the terminal 21 needs to maintain the PPP session in the power-off state when the terminal of the terminal type needs to maintain the PPP session;

when the terminal power-off indication information includes the indication of a terminal maintaining a PPP session, determine that the terminal 21 needs to maintain the PPP session in the power-off state; and

when the terminal power-off indication information includes the M2M terminal power-off indication, acquire, from its own configuration information, information about whether the M2M terminal is supported to maintain the PPP session, and determine that the terminal 21 needs to maintain the PPP session in the power-off state when the M2M terminal is supported to maintain the PPP session.

In a practical application, the first access network 221 and the first circuit domain core network 222 of the network side may be implemented by connecting an access network element with a circuit domain core network element through the Internet; specifically, functions of the first access network 221 and the first circuit domain core network 222 can be implemented by the CPU, or the DSP, or the FPGA in the access network element and the circuit domain core network element.

Preferably, as shown in FIG. 6, the network side 22 includes a second access network 223 and a second circuit domain core network 224; wherein,

the second access network 223 is configured to, after receiving a registration request message from the idle terminal in the packet data session dormant state, transmit through a location update request message the terminal power-off indication information in the registration request message to the second circuit domain core network 224, and after receiving a location update acceptance message, not trigger a PPP session release operation when determining according to the terminal power-off indication information that the terminal 21 needs to maintain the PPP session in the power-off state; and

the second circuit domain core network 224 is specifically configured to accept the registration request about terminal power-off, and send the location update acceptance message to the second access network 223.

The second access network 223 is specifically configured to:

when the terminal power-off indication information only includes the terminal power-off indication, acquire, from other network elements except itself or from storage information, the terminal type and information about whether the terminal of the terminal type needs to maintain the PPP session, and determine that the terminal 21 needs to maintain the PPP session in the power-off state when the terminal of the terminal type needs to maintain the PPP session;

when the terminal power-off indication information includes the terminal power-off indication and the terminal type, acquire, from its own configuration information, information about whether the terminal of the terminal type needs to maintain the PPP session, and determine that the terminal 21 needs to maintain the PPP session in the power-off state when the terminal of the terminal type needs to maintain the PPP session;

when the terminal power-off indication information includes the indication of a terminal maintaining a PPP session, determine that the terminal 21 needs to maintain the PPP session in the power-off state; and

when the terminal power-off indication information includes the M2M terminal power-off indication, acquire, from its own configuration information, information about whether the M2M terminal is supported to maintain the PPP session, and determine that the terminal 21 needs to maintain the PPP session in the power-off state when the M2M terminal is supported to maintain the PPP session.

In a practical application, the second access network 223 and the second circuit domain core network 224 of the network side can be implemented by connecting an access network element with a circuit domain core network element through the Internet; specifically, functions of the second access network 223 and the second circuit domain core network 224 can be implemented by the CPU, or the DSP, or the FPGA in the access network element and the circuit domain core network element.

Preferably, as shown in FIG. 7, the network side 22 includes a third access network 225, a third circuit domain core network 226 and a packet domain core network 227; wherein,

the third access network 225 is configured to, after receiving a release command message from the terminal in the packet session activated state, inform the third circuit domain core network 226 and the packet domain core network 227 to execute an operation of releasing the terminal to enter a dormant state when determining according to the terminal power-off indication information in the release command message that the terminal needs to maintain the PPP session in the power-off state;

the third circuit domain core network 226 is configured to execute the operation of releasing the terminal 21 to enter a dormant state; and

the packet domain core network 227 is configured to execute the operation of releasing the terminal 21 to enter a dormant state.

Preferably, the third access network 225 is further configured to, when the terminal power-off indication information only includes the terminal power-off indication, acquire from other network elements except itself or from storage information the terminal type and information about whether the terminal of the terminal type needs to maintain the PPP session, and determine that the terminal needs to maintain the PPP session in the power-off state when the terminal of the terminal type needs to maintain the PPP session;

the third access network 225 is further configured to, when the terminal power-off indication information includes the terminal power-off indication and the terminal type, acquire, from its own configuration information, information about whether the terminal of the terminal type needs to maintain the PPP session, and determine that the terminal needs to maintain the PPP session in the power-off state when the terminal of the terminal type needs to maintain the PPP session;

the third access network 225 is further configured to, when the terminal power-off indication information includes the indication of a terminal maintaining a PPP session, determine that the terminal needs to maintain the PPP session in the power-off state;

the third access network 225 is further configured to, when the terminal power-off indication information includes the M2M terminal power-off indication, acquire, from its own configuration information, information about whether the M2M terminal is supported to maintain the PPP session, and determine that the terminal needs to maintain the PPP session in the power-off state when the M2M terminal is supported to maintain the PPP session.

In a practical application, the third access network 225, the third circuit domain core network 226 and the packet domain core network 227 can be implemented by connecting an access network element with a circuit domain core network element through the Internet; specifically, functions of the third access network 225, the third circuit domain core network 226 and the packet domain core network 227 can be implemented by the CPU, or the DSP, or the FPGA in the access network element and the circuit domain core network element.

If the terminal and the network side of the present disclosure are implemented in the form of software function module, and when they are sold or used as separate products, they can also be stored in a computer-readable storage medium. Based on such understanding, the technical solution of the present disclosure essentially or the part contributing to the existing technology can be embodied in the form of software product, and the computer software product is stored in a storage medium, and includes a number of instructions for making a computer device (which can be a personal computer, a server, a network device and so on) implement all or part of the method described in each embodiment of the present disclosure. The above mentioned storage medium includes a U flash disk, a mobile hard disk, a Read Only Memory (ROM), a diskette or an optical disk and other medium which can store program codes. Thus, the present disclosure is not limited to any particular combination of hardware and software.

Correspondingly, the present disclosure also provides a computer storage medium which stores a computer program, wherein the computer program is for executing the method for maintaining a PPP session when a terminal is powered off according to embodiments of the present disclosure.

The present disclosure also provides a system for maintaining a PPP session when a terminal is powered off; as shown in FIG. 4, the system includes the terminal 21 and the network side 22 shown in FIG. 5 to FIG. 7.

The implementation process and principle of the method in the present disclosure are elaborated below in combination with embodiments.

### Embodiment 1

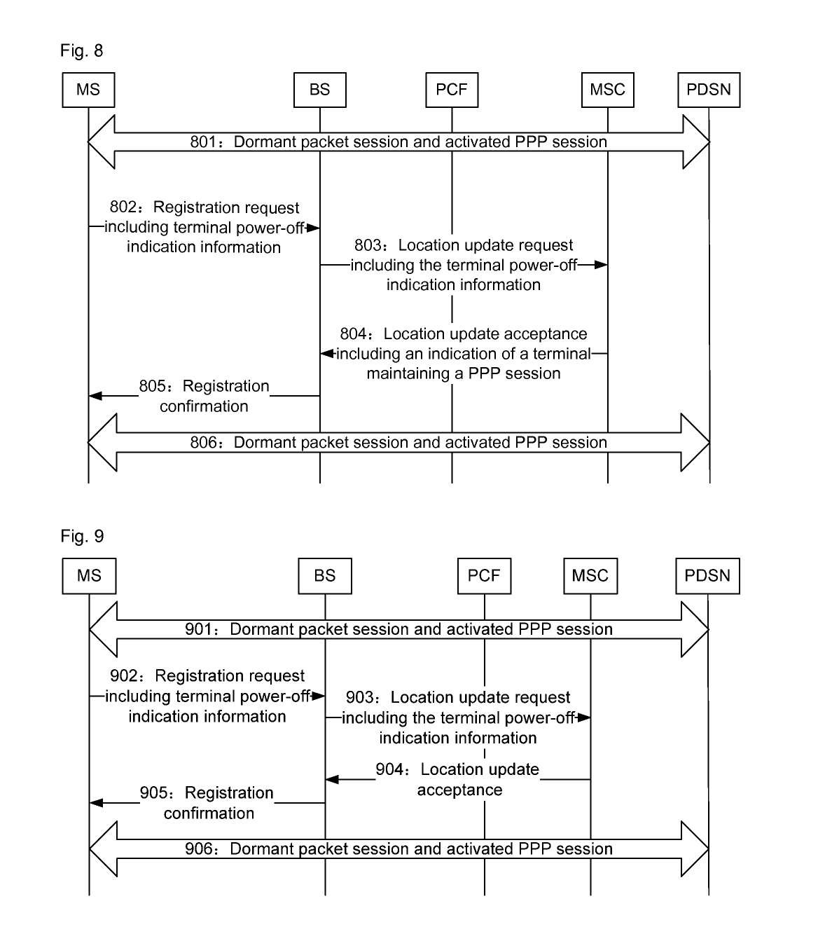

In the present embodiment, the MS is the terminal; the BS, the PCF, the MSC and the PDSN are network elements of the network side, wherein the BS is a network element of the access network, the PCF and the MSC are network elements of the circuit domain core network, and the PDSN is a network element of the packet domain core network; as shown in FIG. 8, the method for maintaining a PPP session when a terminal is powered off in the present embodiment may be implemented by the following steps:

step 801: there are a dormant packet data session and an activated PPP session between the MS and the PDSN;

step 802: the MS sends a registration message including terminal power-off indication information to the BS, wherein the terminal power-off indication information at least includes one of the followings: a terminal power-off indication, a terminal type, an indication of a terminal maintaining a PPP session, and a M2M terminal power-off indication;

step 803: the BS sends a location update request message to the MSC, wherein the location update request message includes the terminal power-off indication information;

step 804: when the MSC determines that the MS needs to maintain a PPP session in the power-off state according to that the packet data session of the MS is in a dormant state, and according to the terminal power-off indication information, the MSC sends a location update acceptance message to the MS, wherein the location update acceptance message includes the indication of a terminal maintaining a PPP session;

wherein, the step of the MSC determining according to the terminal power-off indication information that the MS needs to maintain the PPP session in the power-off state may include: when the terminal power-off indication information only includes the terminal power-off indication, the MSC acquires, from other network elements except itself or from storage information, the terminal type and information about whether the MS of the terminal type needs to maintain the PPP session, and when the MS of the terminal type needs to maintain the PPP session, it is determined that the MS needs to maintain the PPP session in the power-off state;

when the terminal power-off indication information includes the terminal power-off indication and the terminal type, the MSC acquires, from other network elements except itself or from storage information, information about whether the MS of the terminal type needs to maintain the PPP session, and when the MS of the terminal type needs to maintain the PPP session, it is determined that the MS needs to maintain the PPP session in the power-off state;

when the terminal power-off indication information includes the indication of a terminal maintaining a PPP session, it is determined that the MS needs to maintain the PPP session in the power-off state;

when the terminal power-off indication information includes the M2M terminal power-off indication, the MSC acquires, from its own configuration information, information about whether the M2M terminal is supported to maintain the PPP session, and when the M2M terminal is supported to maintain the PPP session, it is determined that the MS needs to maintain the PPP session in the power-off state;

step 805: the BS sends a registration confirmation message to the MS; and

step 806: the dormant packet data session and the activated PPP session are maintained between the MS and the PDSN.

### Embodiment 2

In the present embodiment, the MS is the terminal; the BS, the PCF, the MSC and the PDSN are network elements of the network side, wherein the BS is a network element of the access network, the PCF and the MSC are network elements of the circuit domain core network, and the PDSN is a network element of the packet domain core network; as shown in FIG. 9, the method for maintaining a PPP session when a terminal is powered off in the present embodiment may be implemented by the following steps:

step 901: there are a dormant packet data session and an activated PPP session between the MS and the PDSN;

step 902: the MS sends a registration message including terminal power-off indication information to the BS, wherein the terminal power-off indication information at least includes one of the followings: a terminal power-off indication, a terminal type, an indication of a terminal maintaining a PPP session, and a M2M terminal power-off indication;

step 903: the BS sends a location update request message to the MSC, wherein the location update request message includes the terminal power-off indication information;

step 904: the MSC sends a location update acceptance message to the BS;

step 905: after receiving the location update acceptance message sent by the MSC, the BS determines according to the terminal power-off indication information that the MS needs to maintain the PPP session in the power-off state, and does not trigger a PPP session release operation;

wherein, the step of the BS determining according to the terminal power-off indication information that the MS needs to maintain the PPP session in the power-off state may include that: when the terminal power-off indication information only includes the terminal power-off indication, the BS acquires, from other network elements except itself or from storage information, the terminal type and information about whether the MS of the terminal type needs to maintain the PPP session, and when the MS of the terminal type needs to maintain the PPP session, it is determined that the MS needs to maintain the PPP session in the power-off state;

when the terminal power-off indication information includes the terminal power-off indication and the terminal type, the BS acquires, from its own configuration information, information about whether the MS of the terminal type needs to maintain the PPP session, and when the MS of the terminal type needs to maintain the PPP session, it is determined that the MS needs to maintain the PPP session in the power-off state;

when the terminal power-off indication information includes the indication of a terminal maintaining a PPP session, it is determined that the MS needs to maintain the PPP session in the power-off state;

when the terminal power-off indication information includes the M2M terminal power-off indication, the BS acquires, from its own configuration information, information about whether the M2M terminal is supported to maintain the PPP session, and when the M2M terminal is supported to maintain the PPP session, it is determined that the MS needs to maintain the PPP session in the power-off state; and step 906: the dormant packet data session and the active PPP session are maintained between the MS and the PDSN.

### Embodiment 3

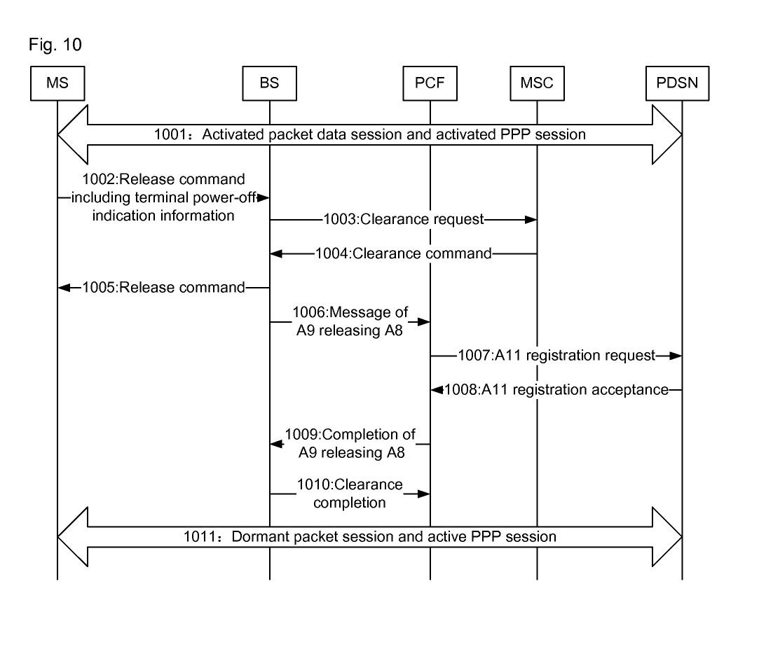

In the present embodiment, the MS is the terminal; the BS, the PCF, the MSC and the PDSN are network elements of the network side, wherein the BS is a network element of the access network, the PCF and the MSC are network elements of the circuit domain core network, and the PDSN is a network element of the packet domain core network; as shown in FIG. 10, the method for maintaining a PPP session when a terminal is powered off in the present embodiment may be implemented by the following steps:

step 1001: there are an activated packet data session and an activated PPP session between the MS and the PDSN;

step 1002: the MS sends a release command message including terminal power-off indication information to the BS, wherein the terminal power-off indication information at least includes one of the followings: a terminal power-off indication, a terminal type, an indication of a terminal maintaining a PPP session, and a M2M terminal power-off indication;

step 1003: the BS determines according to the terminal power-off indication information that the MS needs to maintain the PPP session in the power-off state, and sends a clearance request message to the MSC, wherein the clearance request message includes an indication to let a packet data call enter a dormant state;

wherein, the step of the BS determining according to the terminal power-off indication information that the MS needs to maintain the PPP session in the power-off state may include that: when the terminal power-off indication information only includes the terminal power-off indication, the BS acquires, from other network elements except itself or from storage information, the terminal type and information about whether the MS of the terminal type needs to maintain the PPP session, and when the MS of the terminal type needs to maintain the PPP session, it is determined that the MS needs to maintain the PPP session in the power-off state;

when the terminal power-off indication information includes the terminal power-off indication and the terminal type, the BS acquires, from its own configuration information, information about whether the MS of the terminal type needs to maintain the PPP session, and when the MS of the terminal type needs to maintain the PPP session, it is determined that the MS needs to maintain the PPP session in the power-off state;

when the terminal power-off indication information includes the indication of a terminal maintaining a PPP session, it is determined that the MS needs to maintain the PPP session in the power-off state;

when the terminal power-off indication information includes the M2M terminal power-off indication, the BS acquires, from its own configuration information, information about whether the M2M terminal is supported to maintain the PPP session, and when the M2M terminal is supported to maintain the PPP session, it is determined that the MS needs to maintain the PPP session in the power-off state;

step 1004: the MSC sends a clearance command message to the BS;

step 1005: the BS sends a release command message to the MS;

step 1006: the BS sends the PCF a message of A9 releasing A8, wherein the message includes the indication to let a packet data call enter a dormant state;

step 1007: the PCF sends an A11 registration request message to the PDSN, wherein the A11 registration request message includes a charging data update indication;

step 1008: the PDSN sends an A11 registration acceptance message to the PCF;

step 1009: the PCF sends the BS a completion message of A9 releasing A8;

step 1010: the BS sends a clearance completion message to the MSC, wherein the clearance completion message contains the indication of a terminal maintaining a PPP session; and

step 1011: a dormant packet data session and an activated PPP session exist between the MS and the PDSN.

The above are only the preferred embodiments of the present disclosure, and not intended to limit the scope of the claims of the present disclosure.

1. A method for maintaining a Point-to-Point Protocol (PPP) session when a terminal is powered off, comprising:
receiving terminal power-off indication information sent by a terminal when the terminal is powered off; and
when it is determined according to the terminal power-off indication information that the terminal needs to maintain a PPP session in a power-off state, not triggering a PPP session release operation.

2. The method according to claim 1, wherein the step of receiving terminal power-off indication information sent by a terminal when the terminal is powered off comprises:
receiving, by an access network of a network side, a registration message comprising the terminal power-off indication information, wherein the registration message is sent by the terminal when the terminal which is an idle terminal in a packet data session dormant state is powered off;
the terminal power-off indication information at least comprises one of followings:
a terminal power-off indication, a terminal type, an indication of a terminal maintaining a PPP session, and a Machine to Machine (M2M) terminal power-off indication.

3. The method according to claim 2, wherein the step of when it is determined according to the terminal power-off indication information that the terminal needs to maintain a PPP session in a power-off state, not triggering a PPP session release operation comprises:
after the access network of the network side receives a registration request message from the idle terminal in the packet data session dormant state, transmitting, by the access network, the terminal power-off indication information in the registration request message to a circuit domain core network of the network side through a location update request message;
when the circuit domain core network determines according to the terminal power-off indication information that the terminal needs to maintain the PPP session in the power-off state, sending, by the circuit domain core network, a location update acceptance message to the access network, wherein the location update acceptance message contains the indication of a terminal maintaining a PPP session; and
not triggering, by the access network, the PPP session release operation according to the indication of a terminal maintaining a PPP session.

4. The method according to claim 3, wherein the step of the circuit domain core network determining according to the terminal power-off indication information that the terminal needs to maintain the PPP session in the power-off state comprises:
when the terminal power-off indication information only comprises the terminal power-off indication, acquiring, by the circuit domain core network, from other network elements except itself or from storage information the terminal type and information about whether the terminal of the terminal type needs to maintain the PPP session, and when the terminal of the terminal type needs to maintain the PPP session, determining that the terminal needs to maintain the PPP session in the power-off state;
when the terminal power-off indication information comprises the terminal power-off indication and the terminal type, acquiring, by the circuit domain core network, information about whether the terminal of the terminal type needs to maintain the PPP session from other network elements except itself or from storage information, and when the terminal of the terminal type needs to maintain the PPP session, determining that the terminal needs to maintain the PPP session in the power-off state;
when the terminal power-off indication information comprises the indication of a terminal maintaining a PPP session, determining that the terminal needs to maintain the PPP session in the power-off state;
when the terminal power-off indication information comprises the M2M terminal power-off indication, acquiring, by the circuit domain core network, information about whether the M2M terminal is supported to maintain the PPP session from its own configuration information, and when the M2M terminal is supported to maintain the PPP session, determining that the terminal needs to maintain the PPP session in the power-off state.

5. The method according to claim 2, wherein the step of when it is determined according to the terminal power-off indication information that the terminal needs to maintain the PPP session in the power-off state, not triggering the PPP session release operation comprises:
after the access network of the network side receives a registration request message from the idle terminal in the packet data session dormant state, transmitting, by the access network, the terminal power-off indication information in the registration request message to the circuit domain core network of the network side through a location update request message;
accepting, by the circuit domain core network, a registration request about terminal power-off, and sending a location update acceptance message to the access network; and
receiving, by the access network, the location update acceptance message, determining according to the terminal power-off indication information that the terminal needs to maintain the PPP session in the power-off state, and not triggering the PPP session release operation.

6. The method according to claim 1, wherein the step of receiving terminal power-off indication information sent by a terminal when the terminal is powered off comprises: receiving, by an access network of a network side, a release command message comprising the terminal power-off indication information, wherein the release command message is sent by the terminal when the terminal in a packet session activated state is powered off;
the terminal power-off indication information at least comprises one of followings: a terminal power-off indication, a terminal type, an indication of a terminal maintaining a PPP session, and a M2M terminal power-off indication.

7. The method according to claim 6, wherein the step of when it is determined according to the terminal power-off indication information that the terminal needs to maintain the PPP session in the power-off state, not triggering the PPP session release operation comprises:
after the access network of the network side receives the release command message from the terminal in the packet session activated state, determining, by the access network, according to the terminal power-off indication information in the release command message that the terminal needs to maintain the PPP session in the power-off state, and informing a circuit domain core network and a packet domain core network of the network side to execute an operation of releasing the terminal to enter a dormant state.

8. The method according to claim 5, wherein the step of the access network determining according to the terminal power-off indication information that the terminal needs to maintain the PPP session in the power-off state comprises:
when the terminal power-off indication information only comprises the terminal power-off indication, acquiring, by the access network, from other network elements except itself or from storage information the terminal type and information about whether the terminal of the terminal type needs to maintain the PPP session, and when the terminal of the terminal type needs to maintain the PPP session, determining that the terminal needs to maintain the PPP session in the power-off state;
when the terminal power-off indication information comprises the terminal power-off indication and the terminal type, acquiring, by the access network, information about whether the terminal of the terminal type needs to maintain the PPP session from its own configuration information, and when the terminal of the terminal type needs to maintain the PPP session, determining that the terminal needs to maintain the PPP session in the power-off state;
when the terminal power-off indication information comprises the indication of a terminal maintaining a PPP session, determining that the terminal needs to maintain the PPP session in the power-off state; and
when the terminal power-off indication information comprises the M2M terminal power-off indication, acquiring, by the access network, information about whether the M2M terminal is supported to maintain the PPP session from its own configuration information, and when the M2M terminal is supported to maintain the PPP session, determining that the terminal needs to maintain the PPP session in the power-off state.

9. A method for maintaining a Point-to-Point Protocol (PPP) session when a terminal is powered off, comprising:
when a terminal is in an idle state of a packet data session dormant state, sending, by the terminal, a registration message comprising terminal power-off indication information to a network side when the terminal is powered off;
when the terminal is in a packet session activated state, sending, by the terminal, a release command message comprising terminal power-off indication information to a network side when the terminal is powered off.

10-11. (canceled)

12. A network side, which is configured to receive terminal power-off indication information sent by a terminal when the terminal is powered off, and not trigger a Point-to-Point Protocol (PPP) session release operation when determining according to the terminal power-off indication information that the terminal needs to maintain a PPP session in a power-off state.

13. The network side according to claim 12, wherein the network side is further configured to receive a registration message comprising the terminal power-off indication information, wherein the registration message is sent by the terminal when the terminal which is an idle terminal in a packet data session dormant state is powered off;
the terminal power-off indication information at least comprises one of followings: a terminal power-off indication, a terminal type, an indication of a terminal maintaining a PPP session and a Machine to Machine (M2M) terminal power-off indication.

14. The network side according to claim 13, comprising a first access network and a first circuit domain core network;
the first access network is configured to, after receiving a registration request message from the idle terminal in the packet data session dormant state, transmit, through a location update request message, the terminal power-off indication information in the registration request message to the first circuit domain core network, and not trigger the PPP session release operation according to the indication of a terminal maintaining a PPP session contained in a location update acceptance message which is sent by the first circuit domain core network; and
the first circuit domain core network is configured to, when determining according to the terminal power-off indication information that the terminal needs to maintain the PPP session in the power-off state, send a location update acceptance message to the first access network, wherein the location update acceptance message contains the indication of a terminal maintaining a PPP session.

15. The network side according to claim 14, wherein,
the first circuit domain core network is further configured to, when the terminal power-off indication information only comprises the terminal power-off indication, acquire from other network elements except itself or from storage information the terminal type and information about whether the terminal of the terminal type needs to maintain the PPP session, and determine that the terminal needs to maintain the PPP session in the power-off state when the terminal of the terminal type needs to maintain the PPP session;
the first circuit domain core network is further configured to, when the terminal power-off indication information comprises the terminal power-off indication and the terminal type, acquire, from other network elements except itself or from storage information, information about whether the terminal of the terminal type needs to maintain the PPP session, and determine that the terminal needs to maintain the PPP session in the power-off state when the terminal of the terminal type needs to maintain the PPP session;
the first circuit domain core network is further configured to, when the terminal power-off indication information comprises the indication of a terminal maintaining a PPP session, determine that the terminal needs to maintain the PPP session in the power-off state;
the first circuit domain core network is further configured to, when the terminal power-off indication information comprises the M2M terminal power-off indication, acquire, from its own configuration information, information about whether the M2M terminal is supported to maintain the PPP session, and determine that the terminal needs to maintain the PPP session in the power-off state when the M2M terminal is supported to maintain the PPP session.

16. The network side according to claim 13, further comprising a second access network and a second circuit domain core network; wherein,
the second access network is configured to, after receiving a registration request message from the idle terminal in the packet data session dormant state, transmit through a location update request message the terminal power-off indication information in the registration request message to the second circuit domain core network, and after receiving a location update acceptance message, not trigger the PPP session release operation when determining according to the terminal power-off indication information that the terminal needs to maintain the PPP session in the power-off state; and
the second circuit domain core network is specifically configured to accept a registration request about terminal power-off, and send the location update acceptance message to the second access network.

17. The network side according to claim 12, wherein the network side is further configured to receive a release command message comprising the terminal power-off indication information, wherein the release command message is sent by the terminal when the terminal in a packet session activated state is powered off;
the terminal power-off indication information at least comprises one of followings: a terminal power-off indication, a terminal type, an indication of a terminal maintaining a PPP session and a M2M terminal power-off indication.

18. The network side according to claim 17, further comprising a third access network, a third circuit domain core network and a packet domain core network; wherein,
the third access network is configured to, after receiving the release command message from the terminal in the packet session activated state, inform the third circuit domain core network and the packet domain core network to execute an operation of releasing the terminal to enter a dormant state when determining according to the terminal power-off indication information in the release command message that the terminal needs to maintain the PPP session in the power-off state;
the third circuit domain core network is configured to execute the operation of releasing the terminal to enter a dormant state; and
the packet domain core network is configured to execute the operation of releasing the terminal to enter a dormant state.

19. The network side according to claim 16, wherein,
the second access network and the third access network are further configured to, when the terminal power-off indication information only comprises the terminal power-off indication, acquire from other network elements except themselves or from storage information the terminal type and information about whether the terminal of the terminal type needs to maintain the PPP session, and determine that the terminal needs to maintain the PPP session in the power-off state when the terminal of the terminal type needs to maintain the PPP session;
the second access network and the third access network are further configured to, when the terminal power-off indication information comprises the terminal power-off indication and the terminal type, acquire, from their own configuration information, information about whether the terminal of the terminal type needs to maintain the PPP session, and determine that the terminal needs to maintain the PPP session in the power-off state when the terminal of the terminal type needs to maintain the PPP session;
the second access network and the third access network are further configured to, when the terminal power-off indication information comprises the indication of a terminal maintaining a PPP session, determine that the terminal needs to maintain the PPP session in the power-off state;
the second access network and the third access network are further configured to, when the terminal power-off indication information comprises the M2M terminal power-off indication, acquire, from their own configuration information, information about whether the M2M terminal is supported to maintain the PPP session, and determine that the terminal needs to maintain the PPP session in the power-off state when the M2M terminal is supported to maintain the PPP session.

20. A terminal, comprising a power-off indication module, which is configured to, when the terminal is an idle terminal in a packet data session dormant state, send a registration message comprising terminal power-off indication information to a network side when it is powered off, and also configured to, when the terminal is in a packet session activated state, send a release command message comprising terminal power-off indication information to the network side when the terminal is powered off.

21. The terminal according to claim 20, wherein,
the terminal power-off indication information at least comprises one of followings: a terminal power-off indication, a terminal type, an indication of a terminal maintaining a PPP session and a Machine to Machine (M2M) terminal power-off indication.

22. (canceled)

23. A computer storage medium, storing a computer executable instruction, wherein the computer executable instruction is for executing steps of:
receiving terminal power-off indication information sent by a terminal when the terminal is powered off; and
when it is determined according to the terminal power-off indication information that the terminal needs to maintain a PPP session in a power-off state, not triggering a PPP session release operation.
